(19) United States
(12) Patent Application Publication
(10) Pub. No.: US 2008/0294373 A1
(43) Pub. Date: Nov. 27, 2008

(54) System, software and method for estimating the glycemic load of foods

(76) Inventor: Ronald B. Johnson, Casa Grande, AZ (US)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(21) Appl. No.: 12/154,408

(22) Filed: May 21, 2008

Related U.S. Application Data
(60) Provisional application No. 60/931,713, filed on May 25, 2007.

(51) Int. Cl. G06F 17/18; G06F 19/00

(52) U.S. Cl. 702/179; 708/133

(57) ABSTRACT

A system, software and a method for estimating the Glycemic Load of foods are provided. A multivariate statistical analysis is performed on a known data set of Glycemic Load values for foods to yield a mathematical relationship that best fits the data. The mathematical relationship is then used to calculate an estimation of the Glycemic Load when a food's Glycemic Index (and, hence, Glycemic Load) is unknown based on the food's levels of known nutrients. The estimated Glycemic Load can then be applied to dieting.

### CROSS-REFERENCE TO RELATED PROVISIONAL APPLICATION

This application claims the benefit of U.S. Provisional Patent Application No. 60/931,713 filed on May 25, 2007, the disclosure of which is incorporated herein by reference in its entirety.

### COPYRIGHT NOTICE

A portion of the disclosure of this patent document contains material that is subject to copyright protection. The copyright owner has no objection to the facsimile reproduction of the patent document or patent disclosure as it appears in the U.S. Patent and Trademark Office patent file or records, but otherwise reserves all copyright rights whatsoever.

### BACKGROUND OF THE INVENTION

The present invention generally relates to a new system, software and method for estimating the Glycemic Load of foods, and for applying estimated Glycemic Load to dieting.

The human body performs optimally when blood sugar is kept relatively constant. If blood sugar drops too low, lethargy and increased hunger are the usual result; if blood sugar rises too high, the brain signals the pancreas to secrete more insulin. Insulin brings blood sugar back down—primarily, by converting the excess sugar to stored fat. Also, the greater the rate of increase in blood sugar, the more likely the body will release an excess amount of insulin and drive blood sugar back down too low.

Although increased fat storage may sound bad enough, individuals with diabetes face an even greater problem. The inability of their bodies to secrete or process insulin causes blood sugar to rise too high, leading to a host of additional medical issues.

Many people follow diets designed specifically to decrease the rate of increase and/or total increase of the body's blood sugar. This diet strategy is believed to provide health benefits, such as, for example, reducing the body's need for insulin. This makes this diet strategy of particular interest to individuals suffering from diabetes or other insulin-related diseases. Also, this diet strategy may promote weight loss in certain overweight individuals. Diets based on this strategy typically rely on selecting foods having a Glycemic Index (“GI”) within a predetermined range and/or limiting meals to a predetermined Glycemic Load (“GL”).

The GI is a numerical index that ranks carbohydrates based on their rate of glycemic response, i.e., their conversion to glucose within the body. The purpose behind the GI is, thus, simply to identify foods that have the greatest effect on blood sugar. The GI is measured on a scale of 0 to 100, with higher values given to foods that cause the most rapid rise in blood sugar. Pure glucose serves as a reference point, and is ascribed a GI of 100. GI values are determined experimentally by feeding human test subjects a fixed portion of a given food (after an overnight fast), and subsequently extracting and measuring the amount of glucose in their blood at specific intervals of time.

The GI allows people to compare foods, but does not account for serving size. For this reason, many diets are based on the GL instead of the GI. The GL (first popularized in the late 1990's by Dr. Walter Willett and associates at the Harvard School of Public Health) is an expression of the effect of a food or meal on blood sugar levels. The GL reflects the concept of the GI combined with total food intake, and is calculated by multiplying a food's GI (represented as a percentage) by the total net carbohydrates (i.e., total carbohydrates less dietary fiber) in a given serving of the food. The GL, therefore, indicates the serving's total glycemic response—that is, how much the serving of food is likely to increase blood sugar levels.

GL=GI/100×Net Carbohydrates [1]

Thus, glycemic response can be controlled by consuming low-GI foods and/or by restricting the intake of carbohydrates. As a rule of thumb, most nutrition experts consider a GI of 55 or below to be low and a GI of 70 or above to be high, and a GL of 10 or below to be low and a GL of 20 or above to be high. The table below shows values of GI and GL for some common foods.

GI and GL for Common Foods

| | | | Net | |
|---|---|---|---|---|
| Food | GI | Serving Size | Carbohydrates | GL |
| Peanuts | 14 | 4 oz (113 g) | 15 | 2 |
| Bean sprouts | 25 | 1 cup (104 g) | 4 | 1 |
| Grapefruit | 25 | ½ large (166 g) | 11 | 3 |
| Pizza | 30 | 2 slices (260 g) | 42 | 13 |
| Low fat yogurt | 33 | 1 cup (245 g) | 47 | 16 |
| Apples | 38 | 1 medium (138 g) | 16 | 6 |
| Spaghetti | 42 | 1 cup (140 g) | 38 | 16 |
| Carrots | 47 | 1 large (72 g) | 5 | 2 |
| Oranges | 48 | 1 medium (131 g) | 12 | 6 |
| Bananas | 52 | 1 large (136 g) | 27 | 14 |
| Potato chips | 54 | 4 oz (114 g) | 55 | 30 |
| Brown rice | 55 | 1 cup (195 g) | 42 | 23 |
| Honey | 55 | 1 tbsp (21 g) | 17 | 9 |
| Oatmeal | 58 | 1 cup (234 g) | 21 | 12 |
| Ice cream | 61 | 1 cup (72 g) | 16 | 10 |
| Macaroni and cheese | 64 | 1 serving (166 g) | 47 | 30 |
| Raisins | 64 | 1 small box (43 g) | 32 | 20 |
| White rice | 64 | 1 cup (186 g) | 52 | 33 |
| Sugar (sucrose) | 68 | 1 tbsp (12 g) | 12 | 8 |
| White bread | 70 | 1 slice (30 g) | 14 | 10 |
| Watermelon | 72 | 1 cup (154 g) | 11 | 8 |
| Popcorn | 72 | 2 cups (16 g) | 10 | 7 |
| Baked potato | 85 | 1 medium (173 g) | 33 | 28 |
| Glucose | 100 | (50 g) | 50 | 50 |

A significant problem with diets that rely on the GI or the GL is that the GI values are available for only a very small percentage of the foods that people typically consume. Obtaining unknown GI and GL values is very costly and time consuming, because it requires scientifically controlled tests with multiple human subjects. The shortage of known GI values is compounded by the fact that few laboratories currently test for glycemic values, but thousands of new food products are introduced each year.

Another problem is that the GI is not reliably extendable to “mixed” foods or recipes other than to submit the combination for human testing. That is, for a food created by mixing or otherwise processing two or more foods together with known GIs, the new food's GI cannot be accurately determined. The consequence of this is that a chef or home cook has no practical way to determine the GI or the GL for any of his/her culinary creations.

A further problem is consistency of the GI values. Foods that appear outwardly identical, such as two different servings of cooked carrots, can have divergent GIs depending on the conditions under which they were grown, when they were harvested, how long they were stored, how they were processed, and how long they were cooked.

Yet another problem is that different individuals digest foods at somewhat individual rates, so there can be individual differences in glycemic response and in insulin response from person to person. Therefore, knowledge and use of the GI alone cannot replace individual blood sugar monitoring if such a determination is critical (e.g., for the treatment of diabetes).

Despite the last problem (i.e., individual response), an indicator such as the GI or the GL is quite useful for anticipating glycemic response. What is needed is a way to estimate the GL when the GI is unknown to enable a system that assesses foods in a similar way, but that (i) can be used with all individual foods, (ii) can be used with all mixed foods, (iii) doesn't require costly testing procedures, (iv) provides immediate values, and (v) provides consistent values. The present invention fills this need.

### SUMMARY OF THE INVENTION

Generally speaking, the new system, software and method according to the present invention provide the capability to estimate the GL for foods for which GI and GL values are unknown, and also to apply such estimate to dieting.

In accordance with a preferred embodiment of the present invention, a set of known GL values for foods are obtained and a multivariate statistical analysis is performed on this data set using suitable known techniques. A mathematical relationship is derived based on the multivariate analysis that can be used to generate a calculated estimation of the GL when a food's GI (and, hence, GL) is unknown based on the food's levels of known nutrients (e.g., net carbohydrates, protein, fat) and serving size. The estimated GL is then used to select or monitor intake of foods based on anticipated glycemic response for improving health, including for reducing the body's need for insulin and for managing weight loss.

Exemplary embodiments of the present invention can be implemented in software run on a data processor, in hardware in one or more dedicated chips, or in any combination thereof. For example, embodiments of the present invention can be implemented as a modular software program of instructions which may be executed by an appropriate data processor, as is or may be known in the art. Such a software program can be stored, for example, on a hard drive, flash memory, memory stick, optical storage medium, external storage device, or other data storage devices as are known or may be known in the art.

It is contemplated that exemplary systems according to the present invention will, as appropriate, leverage computer capabilities and electronic communications links which are or may be known in the art. Such systems can include, for example, one or more data processors, one or more interfaces to which are mapped interactive display control commands and functionalities, one or more memories or storage devices, and graphics processors and associated systems.

The foregoing and other aspects, features and advantages of the invention will in part be obvious and will in part be apparent from this disclosure and the accompanying drawings.

The present invention accordingly comprises the features of construction, and combination and arrangement of elements, as well as the several steps and the relation of one or more of such steps with respect to each of the others, all as exemplified in the following detailed disclosure and accompanying drawings, and the scope of the invention will be indicated in the claims.

### BRIEF DESCRIPTION OF THE DRAWINGS

For a fuller understanding of the present invention, reference is had to the following description taken in connection with the accompanying drawings, in which:

FIGS. 1A to 1N show a representative input/output from a regression analysis performed on a data set of GL values in accordance with an embodiment of the present invention;

FIG. 2 is a graphical comparison between actual GLs and estimated (in accordance with an embodiment of the present invention) GLs for over 200 common carbohydrate-containing foods;

FIG. 3a is a graphical comparison between actual GLs and estimated (in accordance with the embodiment of the present invention represented by relationship [2]) GLs for over 150 foods for which both the GL and the carbohydrate conversion factor are known and for which the GL is non-zero;

FIG. 3b is a graphical comparison between actual GLs and estimated (in accordance with the embodiment of the present invention represented by relationship [3]) GLs for over 150 foods for which both the GL and the carbohydrate conversion factor are known and for which the GL is non-zero; and

FIGS. 4 to 4-5 represent the data set underlying the comparative graphical representations depicted in FIGS. 3a and 3b.

### DETAILED DESCRIPTION OF THE PREFERRED EMBODIMENTS

In accordance with a preferred embodiment of the present invention, a set of known GL values for given foods derived from GI values determined via human testing are obtained and, preferably, stored in a data file. Supplemental data can be added to the data set—for example, it is desirable to add known nutrient values for the given foods. It is also preferable to eliminate entries where GI=0 and calories from carbohydrates>0 (the known GI data sometimes record very low GIs as zero; this may be practical for typical use, but is inaccurate for purposes of the present invention).

A multivariate statistical analysis is then performed on the GL data set using suitable known techniques (which can be effected via known computer algorithms). Any necessary or otherwise appropriate statistical optimization “fitting” techniques are applied to the results to yield a mathematical relationship that best fits the data.

As is known to those of ordinary skill in the art, multivariate statistical analysis involves observation and analysis of more than one statistical variable at a time. There are many known suitable models:
Regression analysis attempts to determine a linear formula that can describe how some variables respond to changes in others.
Principal components analysis attempts to determine a smaller set of synthetic variables that can explain the original set.
Linear discriminant analysis computes a linear predictor from two sets of normally distributed data to allow for classification of new observations.
Discriminant function or canonical variate analysis attempt to establish whether a set of variables can be used to distinguish between two or more groups.
Logistic regression estimates and tests the influence of covariates on a binary response.
Multivariate analysis of variance (MANOVA) methods extend analysis of variance methods to cover cases where there is more than one dependent variable and where the dependent variables cannot simply be combined.
Artificial neural networks extend regression methods to non-linear multivariate models.
Multidimensional scaling covers various algorithms to determine a set of synthetic variables that best represent the pairwise distances between records.
Canonical correlation analysis attempts to establish whether or not there are linear relationships among two sets of variables (covariates and response).

In accordance with a preferred embodiment of the present invention, the regression analysis model is employed. It should be appreciated, however, that other multivariate statistical analysis techniques (including but not limited to the techniques identified above) can be used.

Regression analysis involves determining the values of parameters for a function that cause the function to best fit the given data set. For example, in linear regression, the function is a linear (straight-line) equation.

Regression analysis is more than curve fitting (choosing a curve that best fits given data points)—it involves fitting a model with both deterministic and stochastic components. The regression analysis performed will determine the best values for the given parameters.

Regression can be expressed as a maximum likelihood method of estimating the parameters of a model. However, for small amounts of data, this estimate can have high variance. Accordingly, the more selections provided, generally, the more accurate the estimate of the parameters.

If a perfect fit existed between the relationship generated as a result of regression analysis and the actual data, each value input into the generated relationship would exactly equal the predicted value. However, this may not be the case, and the difference between the actual value and the predicted value is the error of the estimate or “deviation.” In such circumstances, it is desirable that the results of the regression analysis on the data set be optimized using suitable known statistical “fitting” techniques.

Regression is usually posed as an optimization problem aimed at finding a solution where the error is at a minimum. The most common error measure that is used is the least squares—this corresponds to a Gaussian likelihood of generating observed data. The optimization problem can typically be solved by the use of algorithms such as, for example, gradient descent algorithms, the Gauss-Newton algorithm, and the Levenberg-Marquardt algorithm. Probabilistic algorithms can also be used to find a good fit for a data set.

In arriving at an equation for estimating the GL in accordance with a preferred embodiment of the present invention, each suggested equation based on the given data set is preferably examined and iteratively tested against nutrient values from other foods. Adjustments can then be made to the data set—e.g., selecting which nutrients to use as independent variables.

In the development of the present invention, it was initially sought to approximate the GI (rather than the GL) utilizing a data set containing actual GI values and additional nutrient data for 485 foods. Metrics relating to the foods' (i) predicted satiating effect based on nutrient content and (ii) nutrient density were incorporated as independent variables (a discussion of predicted satiating effect and nutrient density rating is set forth in commonly-assigned U.S. Ser. No. 11/302,080 which is incorporated herein by reference in its entirety).

While the glycemic response is known to be related to carbohydrate digestion, it was recognized that a food's protein, fat and fiber content can also influence it. These non-carbohydrate nutrients have a delayed rate of digestion relative to carbohydrates, and it was hypothesized that they may, in turn, impede the absorption of carbohydrates to some degree.

Regression analysis applied to this data set yielded the following relationship for the estimated Glycemic Index (eGI):

$$eGI = 7.539885 + 14.03401 * x 1 \hat{} 0.4 + 0.000298 * x 4 \hat{} 3 - 7.4915 E - 06 * x 3 \hat{} 3 - 0.752760 * x 2 + 0.009913 * e \hat{} x 5 + 2.3265 E - 140 * e \hat{} ( x 2 * x 5 ) - 0.001033 * x 1 * x 3 * x 5 + 3.4466 E - 11 * ( x 2 * x 3 * x 5 ) \hat{} 3 + 4.6774 E - 13 * ( x 1 * x 3 * x 4 ) \hat{} 3 + 3.9948 E - 09 * ( x 1 * x 4 * x 5 ) \hat{} 3 + 0.299763 * e \hat{} ( - x 4 * x 5 ) + 1.401466 * e ( - x 1 * x 2 * x 3 ) - 3.9690 E - 11 * ( x 2 * x 3 * x 4 ) \hat{} 3 - 0.125173 * x 1 * x 4 + 1.2047 E - 11 * ( x 1 * x 3 ) \hat{} 3 + 2.1075 E - 07 * ( x 1 * x 5 ) \hat{} 3 - 9.069528 * e ( - x 2 * x 4 )$$

where:

x1=% of calories from carbohydrates;

x2=% of carbohydrates as fiber;

x3=% of carbohydrates as sugars;

x4=predicted satiating effect; and

x5=nutrient density rating.

This result had an unacceptably high variance, possibly due to missing independent variables. A less complex linear regression performed on the same data set yielded the following relationship:

eGI=7.806841+0.701511*x1−4.826993*x4−0.119193*x3−0.266943*x2+2.870038*x5

The statistics for this regression were mixed. There was better autocorrelation (i.e., Durbin-Watson statistic), but higher standard error.

As development of the present invention progressed, the data set was expanded to include 607 entries by including more foods with GIs known to be zero, and additional independent variables representing individual sugars. Regression performed on this data set was then effected without transformations or interactive terms and yielded the following relationship:

eGI=28.97719+0.682838*x11−0.977769*x3+1.041121*x5−0.279360*x2+0.647169*x6+0.387291*x9+0.369855*x4+0.176398*x10

where:

x1=calories/100 g;

x2=fat g/100 g;

x3=protein g/100 g;

x4=fiber g/100 g;

x5=starch g/100 g;

x6=glucose g/100 g;

x7=fructose g/100 g;

x8=galactose g/100 g;

x9=sucrose g/100 g;

x10=lactose g/100 g; and

x11=undifferentiated carbohydrates g/100 g.

Analysis suggested that this model was most dependent on the last independent variable—namely, remaining carbohydrates, undifferentiated.

With the belief that the data on individual sugars were important, it was suspected that the results were being adversely affected by a low quality of sugars data. To improve the data set, any entry for which undifferentiated carbohydrates>differentiated carbohydrates was eliminated. Regression was performed on the resulting data set of 435 entries and yielded the following relationship:

$$eGI = 3.940533 + 2.816455 * x 5 + 1.017851 * x 6 - 0.129046 * x 3 - 0.038766 * x 2 + 0.693330 * x 9 + 0.417977 * x 10 + 11.21686 * x 11 + 0.421854 * x 4 + 5.039087 * x 8 + 63.09815 * x 4 * x 8 * x 9 + 0.013241 * x 5 * x 6 * x 11 - 0.001911 * x 1 * x 3 * x 4 - 0.001101 * x 1 * x 6 * x 9 - 0.000132 * x 1 * x 5 * x 9 + 0.354094 * x 5 * x 7 * x 9 + 1.644929 * x 3 * x 10 - 0.162972 * x 7 * x 9 - 0.100943 * x 3 * x 5 * x 10 + 46.27552 * x 2 * x 8 * x 11 + 0.105894 * x 2 * x 5 * x 7 - 0.543848 * x 5 * x 11 - 0.006404 * x 6 * x 7 * x 11 - 0.067160 * x 9 * x 11 + 259.0752 * x 5 * x 8 * x 11 - 23.81621 * x 3 * x 8 - 0.749780 * x 3 * x 11 - 2.560297 * x 5 * x 7 * x 10 - 0.112552 * x 4 * x 5 * x 6 + 194.8809 * x 3 * x 8 * x 10 + 0.019586 * x 2 * x 5 * x 11 + 1.181740 * x 4 * x 9$$

This equation had an improved fit for this data set, but was very complex, and it appeared that the calculated values could vary wildly for foods outside of this particular data set. Another disadvantage was that the available data for individual sugars were very limited—i.e., such data are infrequently measured during food composition testing and rarely tested for packaged foods.

Consideration was then given to using two alternative equations—one from a previous attempt when sufficient data were known about individual sugars, the other from another previous attempt when such data were not available. This aimed at determining a more general secondary equation (based on 603 entries), and yielded the following relationship:

$$eGI = 17.84828 + 2.458326 * x 5 - 0.666338 * x 3 - 0.075612 * x 1 + 3.419510 * x 4 + 0.016877 * x 3 * x 5 - 3.8733 E - 06 * x 1 * x 2 * x 3 + 0.000524 * x 1 * x 4 * x 5 - 0.004664 * x 1 * x 5 + 0.043610 * x 2 * x 5 - 0.002511 * x 2 * x 3 * x 4 + 0.002539 * x 1 * x 3 - 0.224577 * x 4 * x 5 - 0.002839 * x 2 * x 4 * x 5 - 0.001502 * x 2 * x 3 * x 5 + 0.000555 * x 1 * x 2$$

The foregoing approach was determined not to be sufficiently reliable to be of practical use.

As a different approach, it was determined to model the GL (for a 100 g serving) instead of the GI. Initially, only the most basic and highest correlated variables from previous attempts were utilized. Regression was performed on this data set of 554 entries and yielded the following relationship:

$$eGL 100 = 1.548739 + 0.311027 * x 2 - 0.224416 * x 5 - 0.046016 * x 4 - 0.001772 * x 1 - 0.001100 * x 2 * x 3 * x 4 + 8.3815 E - 06 * x 1 * x 2 * x 4 + 0.001008 * x 1 * x 2 + 0.001093 * x 3 * x 4 * x 5 - 0.000600 * x 2 * x 3 * x 5 + 0.000444 * x 2 * x 4 * x 5$$

where:

x1=calories/100 g;

x2=net carbohydrates g/100 g;

x3=fat g/100 g;

x4=protein g/100 g; and

x5=fiber g/100 g.

To improve fit, data transformations were added to the regression analysis. Analysis of 554 entries yielded the following relationship:

$$eGL 100 = 1.901534 + 0.184699 * x 2 \hat{} 1.3 - 0.730187 * e \hat{} ( - x 5 ) - 2.626899 * e \hat{} ( - x 4 ) + 2.3785 E - 43 * e \hat{} x 3 - 0.005569 * x 1$$

Given that the GL is zero when a food contains no carbohydrates, it was recognized that no equation is needed to estimate the GL if net carbohydrates=0. The zero-carb data in the data set, however, could be negatively and disproportionately influencing the regression fit. So, the data set was refined by eliminating zero-carb listings. Regression performed on this data set of 231 entries yielded the following relationship:

eGL100=2.673997+0.075562*x2̂1.5−7.004972*ê(−x4)−0.000046*x3̂3−0.116160*x5+108.0237*x1̂−1

The data set was then error-checked and further refined by eliminating entries for non-ready-to-eat foods. This further refinement was based on the recognition that it is not important to be able to predict the GL for raw chicken, flour, or other ingredient-level foods. Regression on the refined data set of 224 entries yielded the following relationship:

eGL100=2.571285+0.117663*x2̂1.4−3.873729*ê(−x4)−0.000059*x3̂3

where:

x2=net carbohydrates g/100 g;

x3=fat g/100 g; and

x4=protein g/100 g.

It is theoretically not possible for the GI to exceed 100. The consequence of this is that the GL cannot exceed the total number of net carbohydrates in a serving. The GL also cannot be less than zero.

Recognizing the foregoing, upper and lower limits were placed on the resulting equation. The equation was also adjusted to scale for any serving size (other than 100 g). The equation's coefficients were also rounded slightly, since the extra precision was deemed unnecessary. Because the GL is only positive for carbohydrate-containing foods, the equation need only be used for that condition.

This process yielded the following inventive relationship for estimated Glycemic Load (eGL):

IF NC=0 THEN eGL=0

ELSE eGL=SWT/100*MAX(0,MIN(NC,(X₁+X₂*NĈX₃−X₄*ê(−P)−X₅*F̂X₆))) [2]

where:
SWT is the serving weight (in grams);
NC is net carbohydrates (in grams) per 100 g serving net carbohydrates being equal to total carbohydrates less any dietary fiber;
P is protein (in grams) per 100 g serving;
F is fat (in grams) per 100 g serving;
e is the mathematical constant known as Napier's constant;
MAX(a,b) is a function that returns the maximum of a or b;
MIN(a,b) is a function that returns the minimum of a or b; and
X₁ through X₆ have the approximate following values:
   X₁=2.571,
   X₂=0.1177,
   X₃=1.4,
   X₄=3.874,
   X₅=0.000059, and
   X₆=3.0.

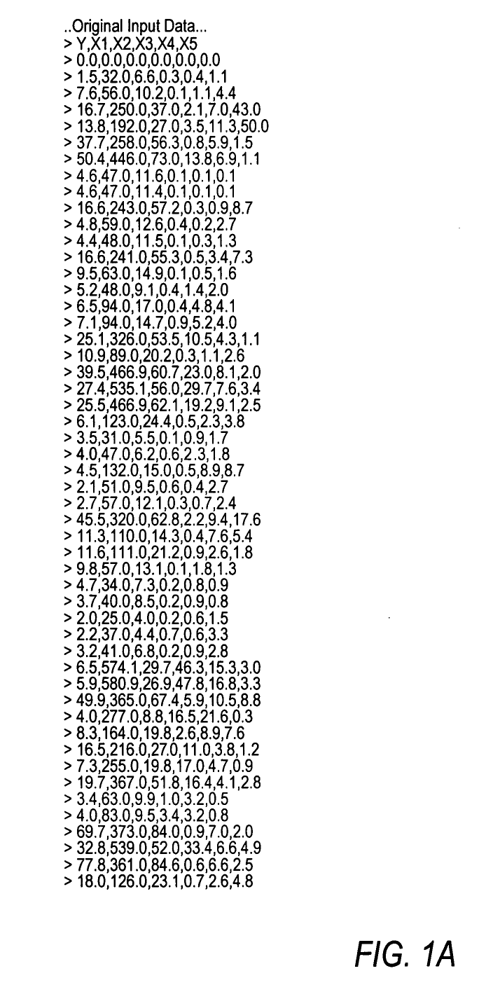

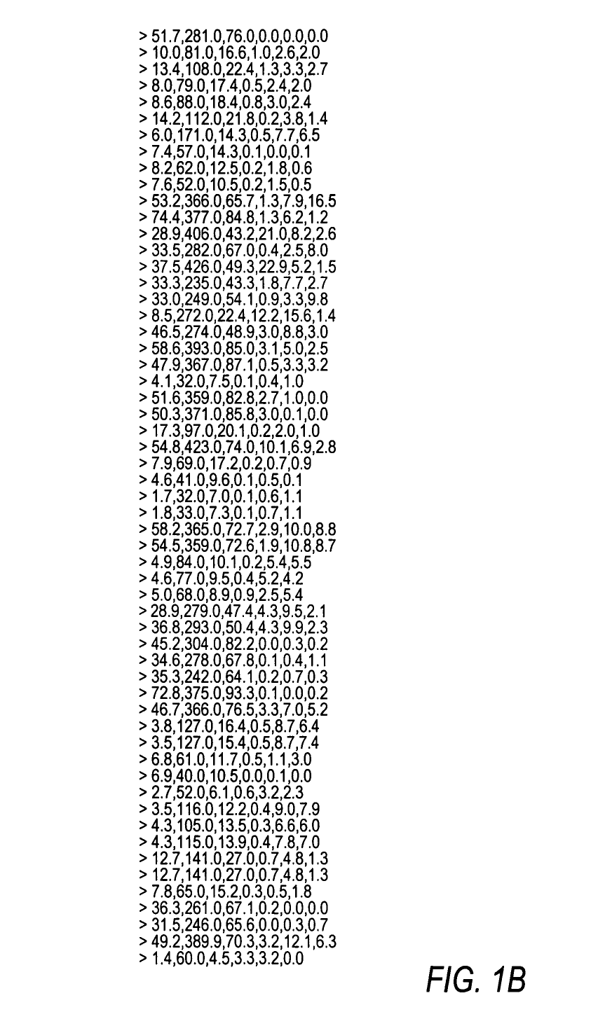

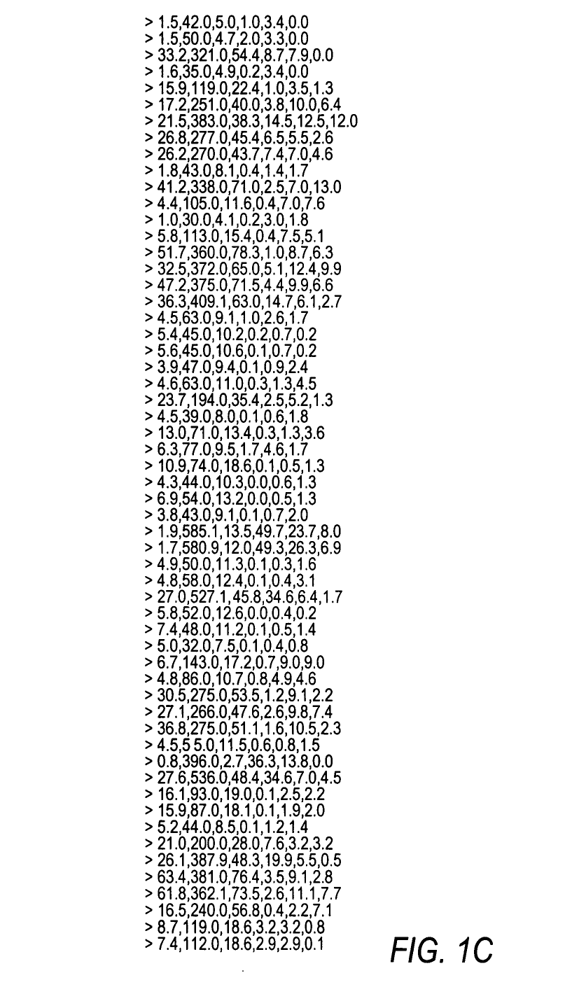

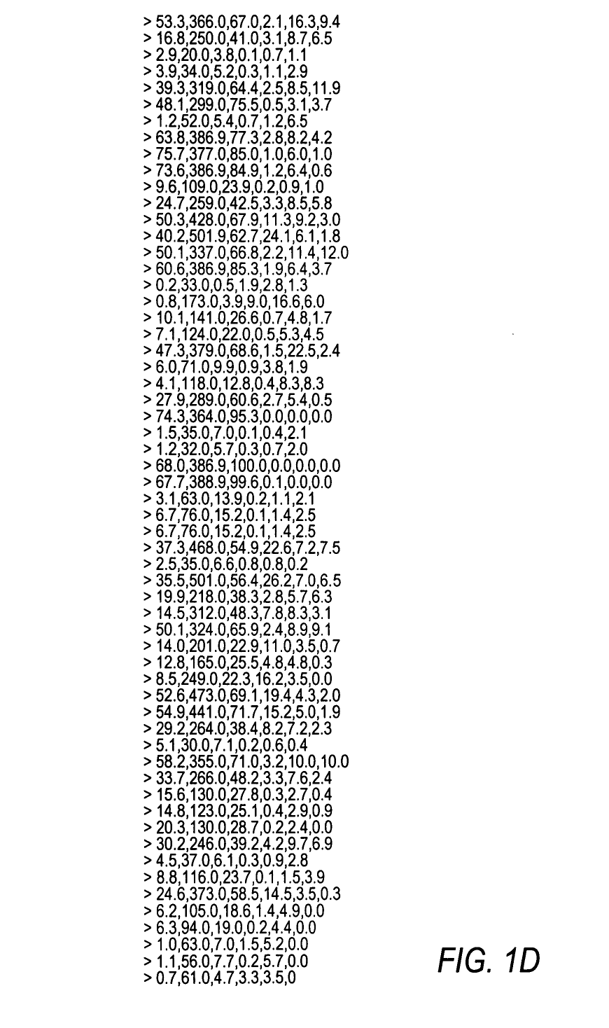

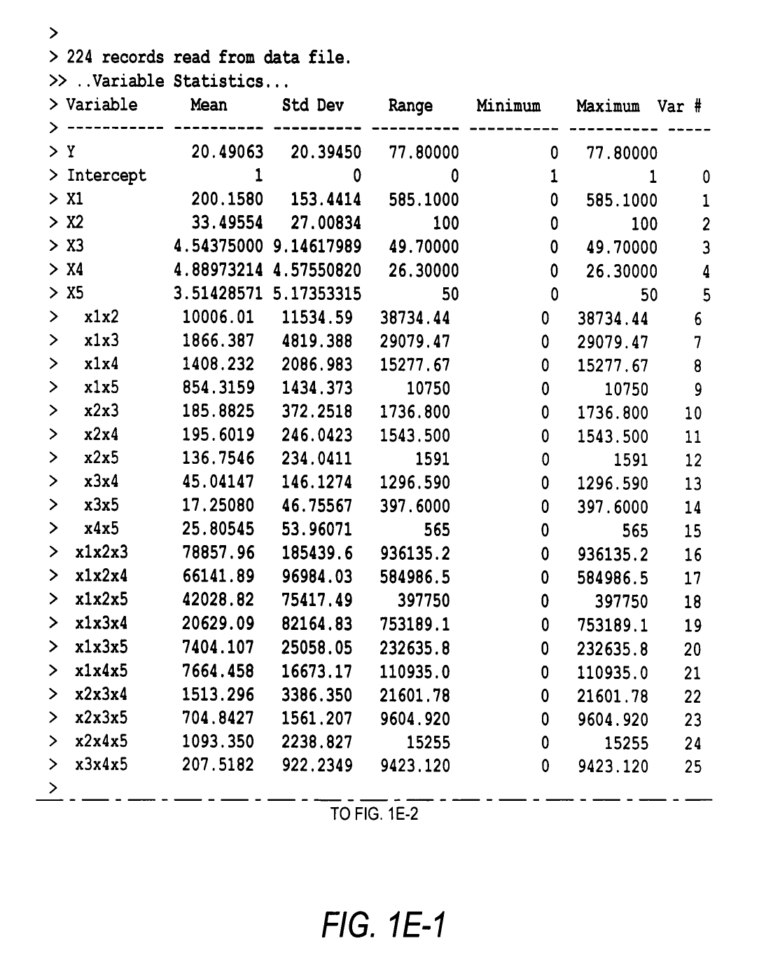

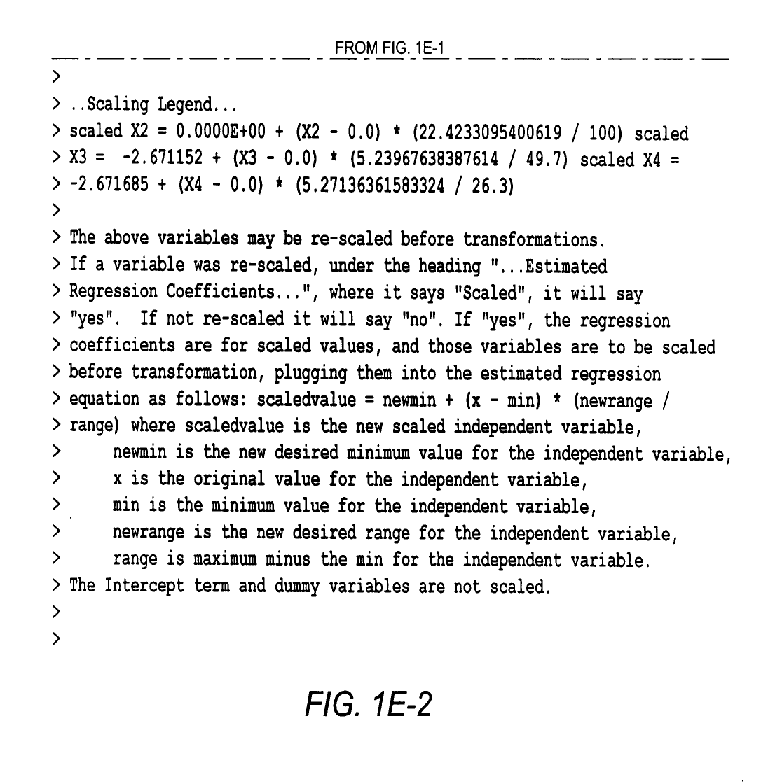

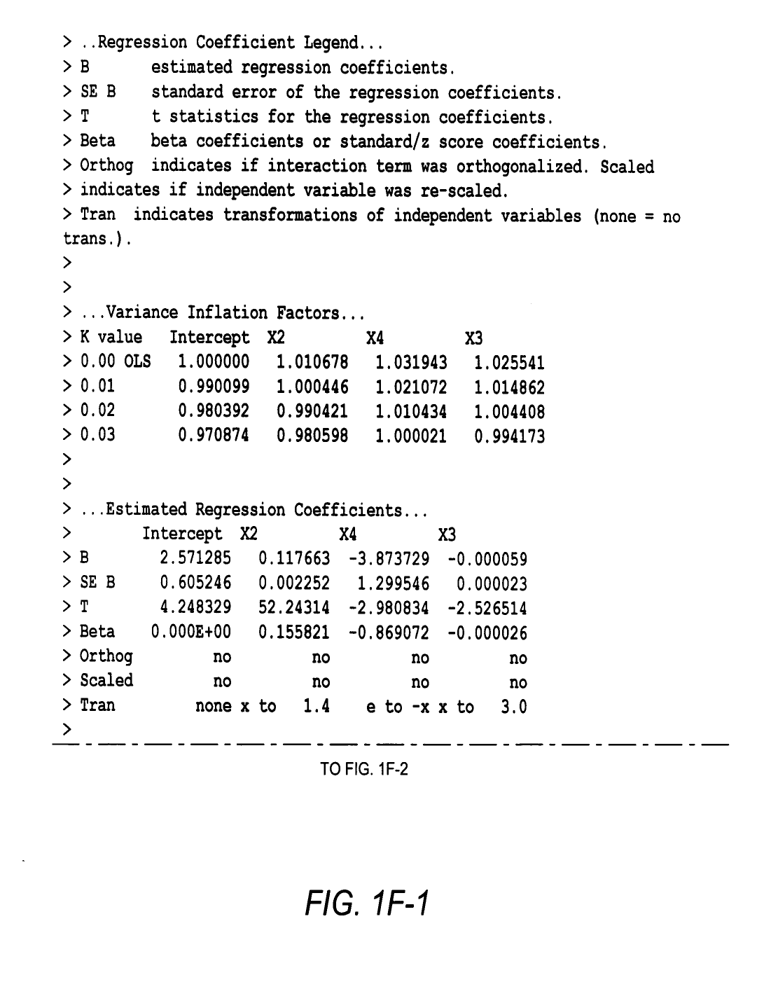

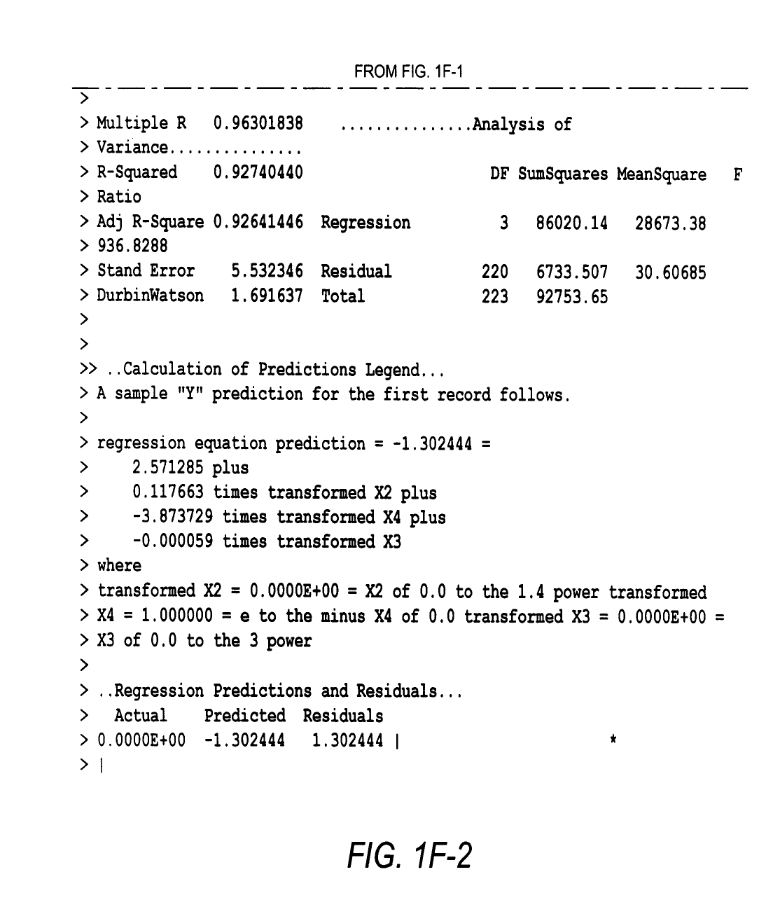

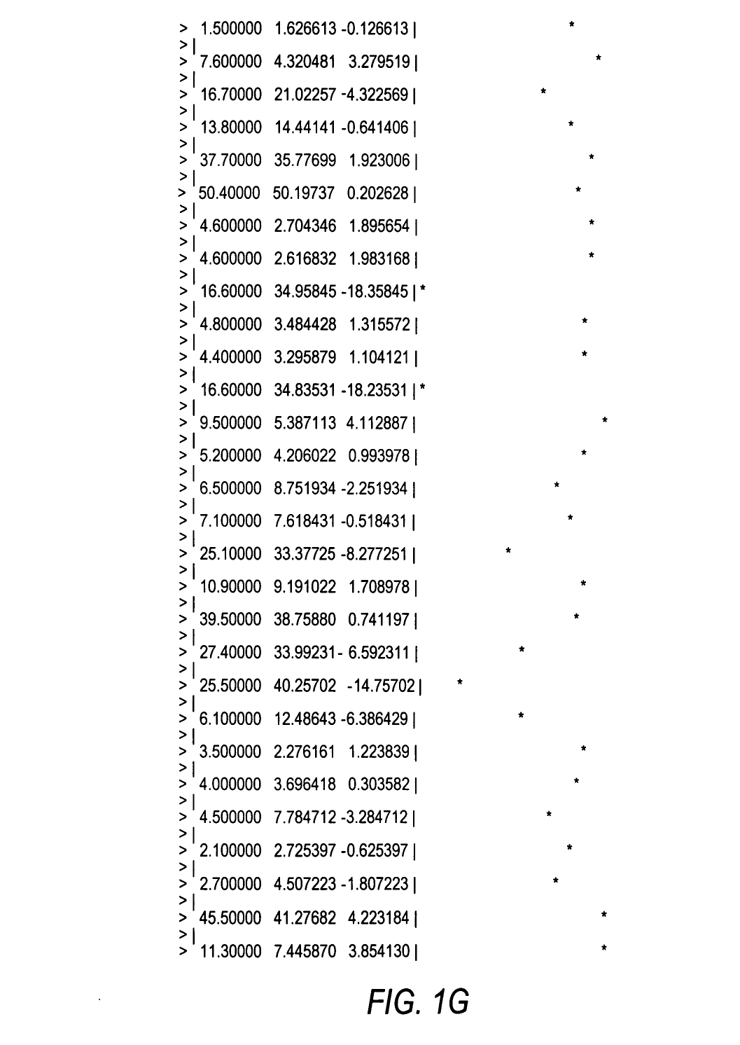

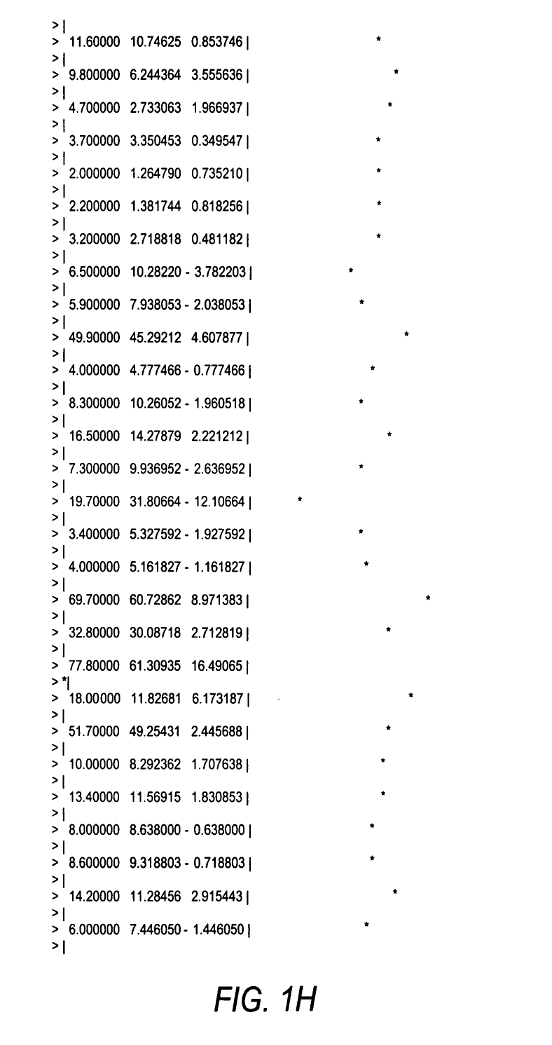

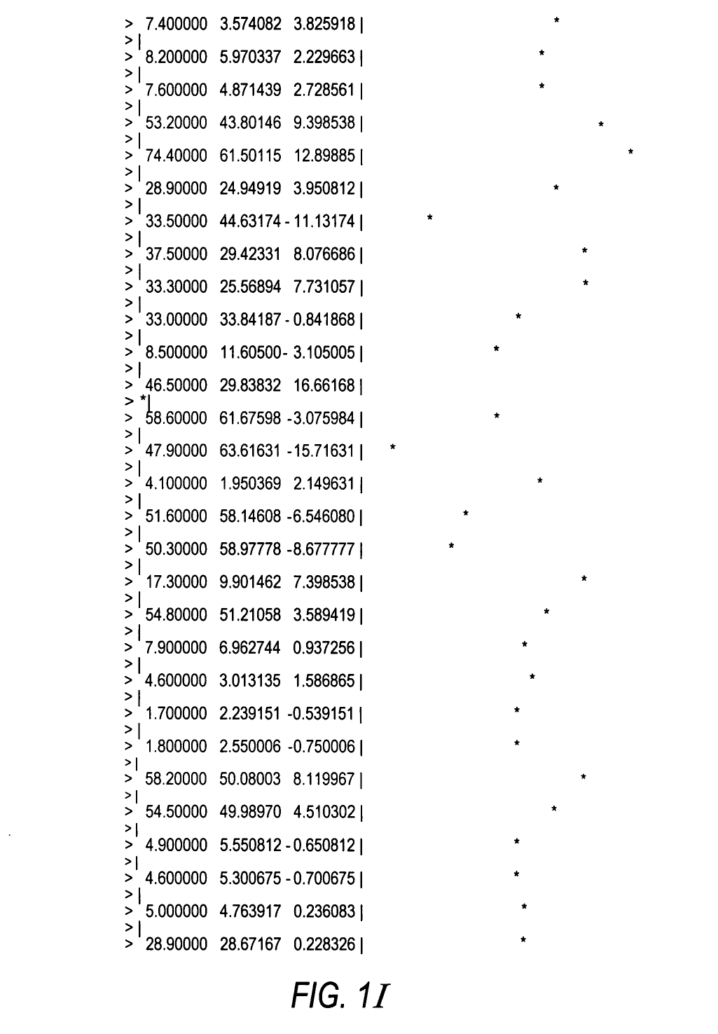

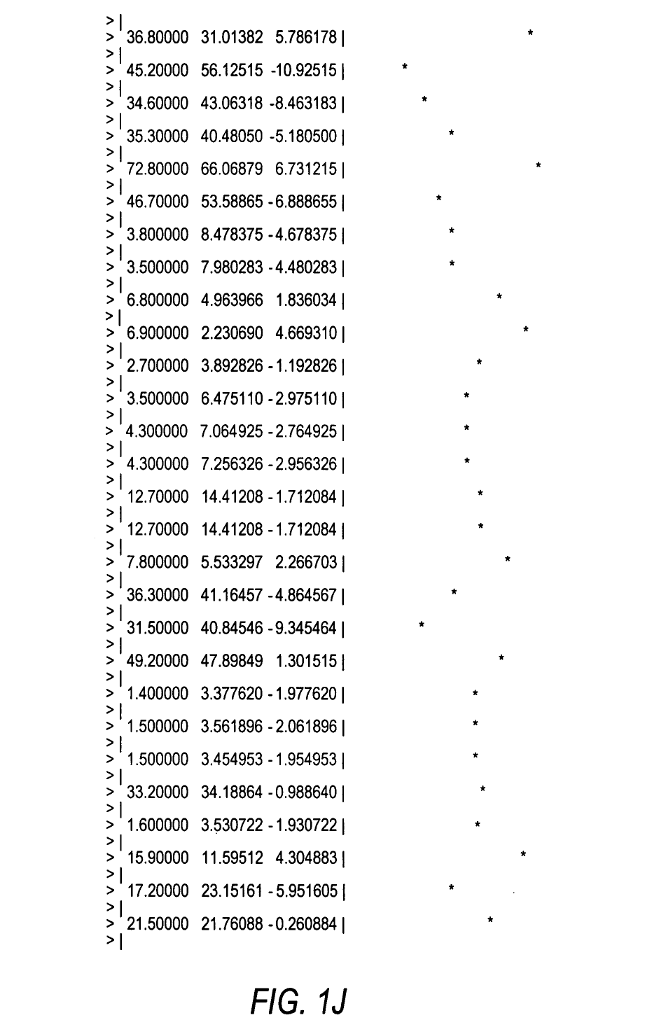

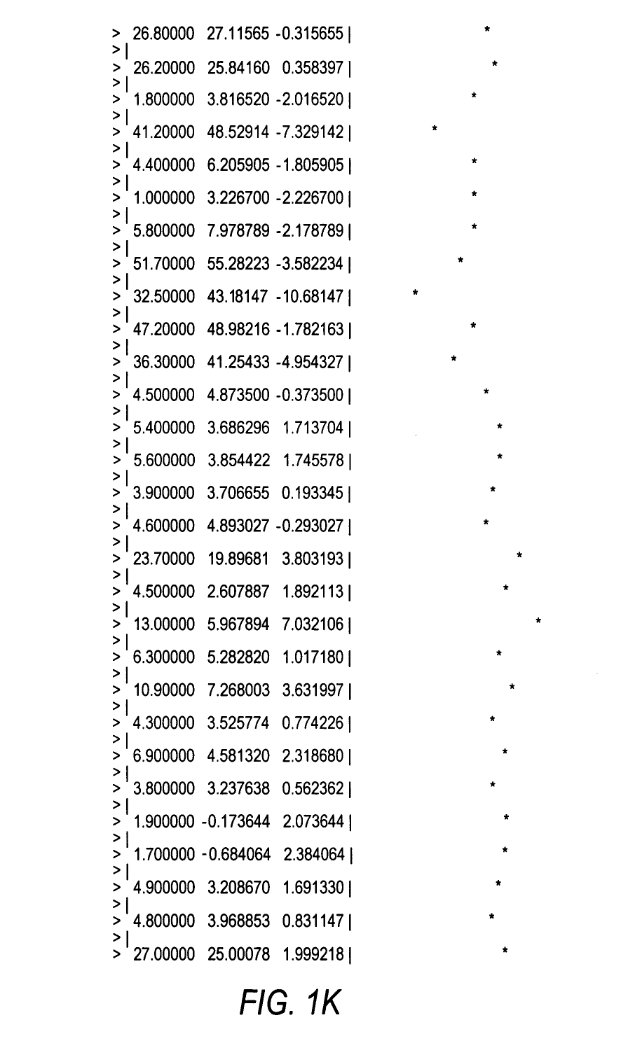

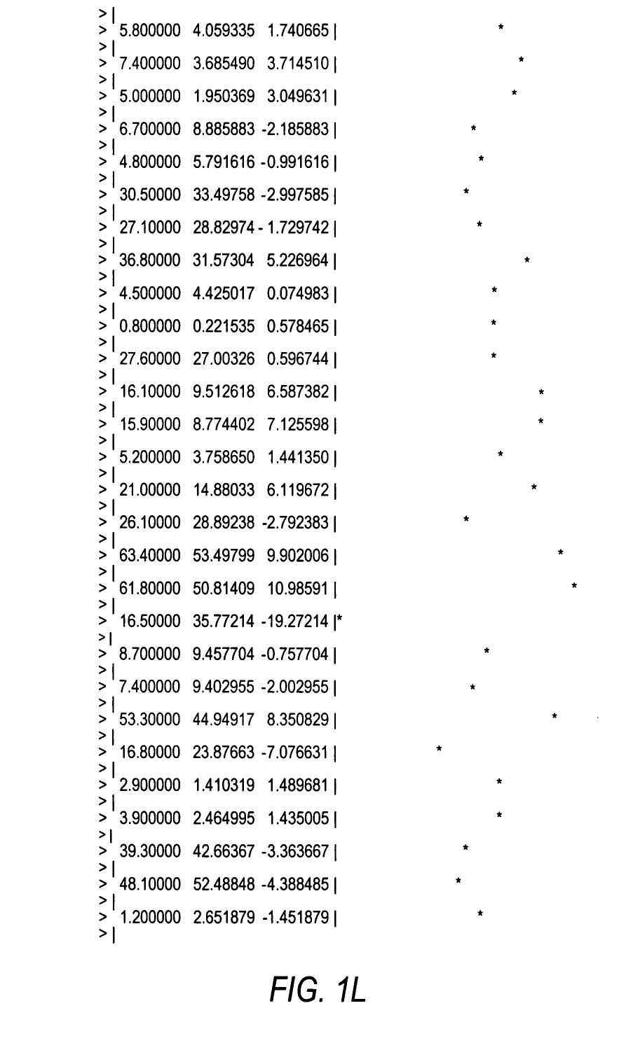

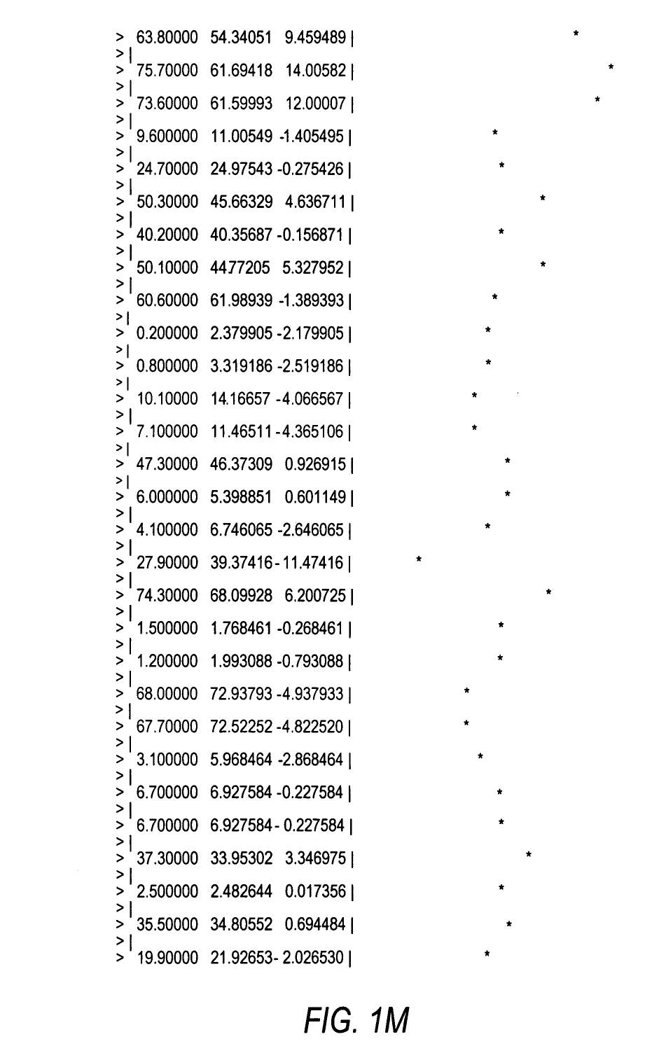

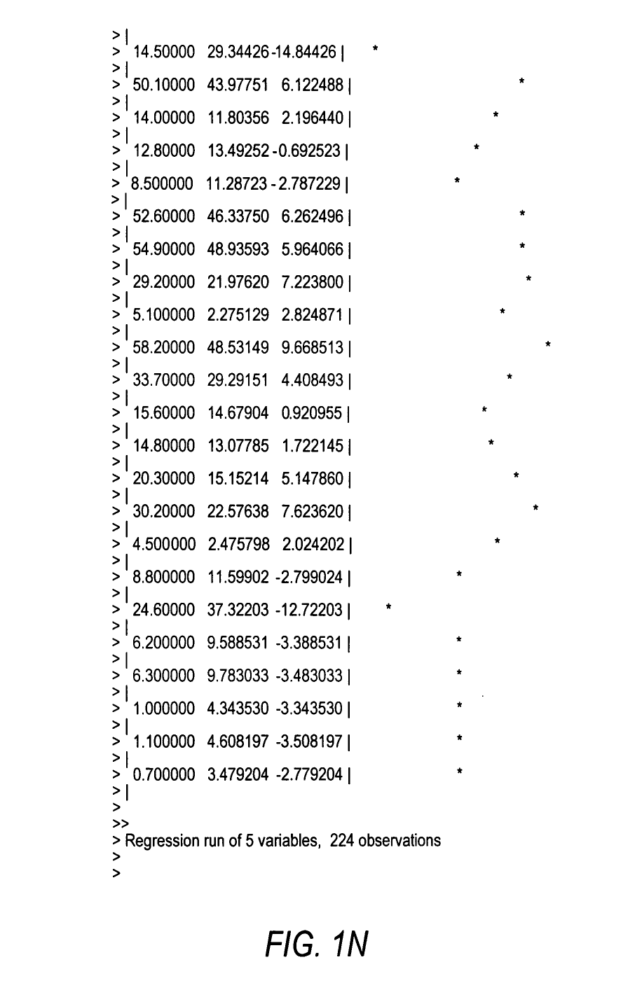

FIGS. 1A to 1N show a sample input/output from a regression analysis performed on a data set of glycemic values for foods used to derive relationship [2] according to the present invention.

Relationship [2] can be used to calculate and present to the user an estimation of the GL when a food's GI is unknown by obtaining and populating the relationship with the food's specific levels of commonly known nutrients (e.g., net carbohydrates, protein, fat) and serving weight. Because of nutrition labeling laws, the nutrient value inputs to relationship [2] are typically already available for most foods. When this is not the case, they can be determined from conventional methods of food composition analysis.

The eGL can be calculated for mixed foods in the same way that it is calculated for an individual food. Also, the eGL can be calculated for liquids including soups and beverages.

By way of example, a typical commercially prepared blueberry muffin contains 47.8 grams of net carbohydrates, 5.3 grams of protein, and 19.2 grams of fat per 100 grams. The approximate serving weight of a small blueberry muffin is 66 grams. Therefore, the eGL according to the present invention is 18.8 for this product:

$$\begin{matrix}eGL = 66 / 100 * MAX ( 0 , MIN ( 47.8 , 2.571 + 0.1177 * \\ 47.8 \hat{} 1.4 - 3.874 * e \hat{} ( - 5.3 ) - 0.000059 * 19.2 \hat{} 3 ) ) \\ = 0.66 * MIN ( 47.8 , 28.557 ) \\ = 18.8\end{matrix}$$

This product example is one for which the GI is known (i.e., from human testing) to be 59. So, for verification purposes, the GL for this product can also be determined in conventional manner using equation [1]:

$$\begin{matrix}GL = 59 / 100 * net carbohydrates \\ = 59 / 100 * ( 66 / 100 * 47.8 ) \\ = 18.6\end{matrix}$$

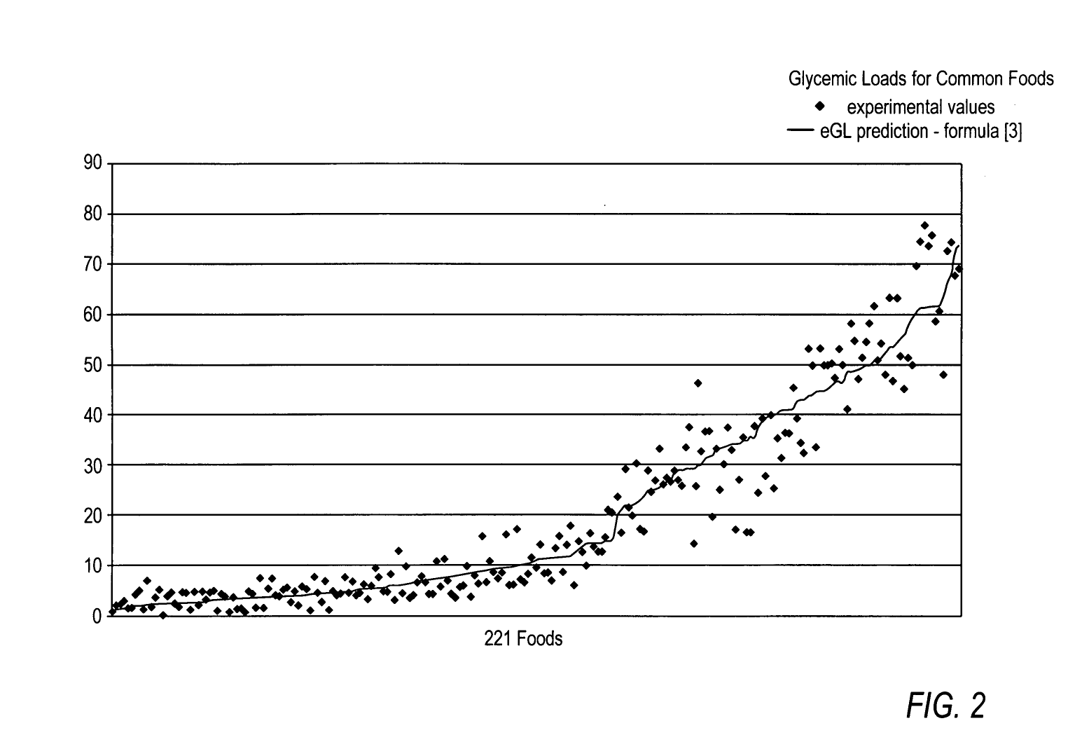

FIG. 2 depicts a graphical comparison between actual and estimated GLs for over 200 common carbohydrate-containing foods (the source of the GL data is the International Table of Glycemic Index and Glycemic Load Values: 2002). In the graph depicted in FIG. 2, each diamond represents the measured GL for a particular food. The black line represents the eGL generated using the inventive relationship [2]. For each food considered, a serving size of 100 grams was used. The mean GL for foods was 20.8, and the resulting eGL relationship had a standard error of 5.5.

Many foods in the dietetic/diabetic class contain sugar alcohols. These modified carbohydrates are listed on Nutrition Facts labels as carbohydrates, but provide considerably fewer calories per gram (sugar alcohols are usually added to a food in combination with artificial sweeteners as a way of replacing sugar, to minimize calories and limit diabetic response). Recognizing the foregoing, the modified embodiment of relationship [2] set forth below compensates for overestimation of GL for dietetic/diabetic foods by weighting net carbohydrates by the carbohydrate conversion factor (CF)/4:

eGL=SWT/100*MAX(0,MIN(NC,(X₁+X₂*(NC*CF/4)̂X₃−X₄*ê(−P)−X₅*F̂X₆))) [3]

where:

SWT is the serving weight (in grams);

NC is net carbohydrates (in grams) per 100 g serving;

P is protein (in grams) per 100 g serving;

F is fat (in grams) per 100 g serving;

CF is the carbohydrate conversion factor (default to 4.0 if unknown);

e is the mathematical constant known as Napier's constant;

MAX(a,b) is a function that returns the maximum of a or b;

MIN(a,b) is a function that returns the minimum of a or b;

X₁ through X₆ have the approximate following values:
X₁=2.571,
X₂=0.1177,
X₃=1.4,
X₄=3.874,
X₅=0.000059, and
X₆=3.0.

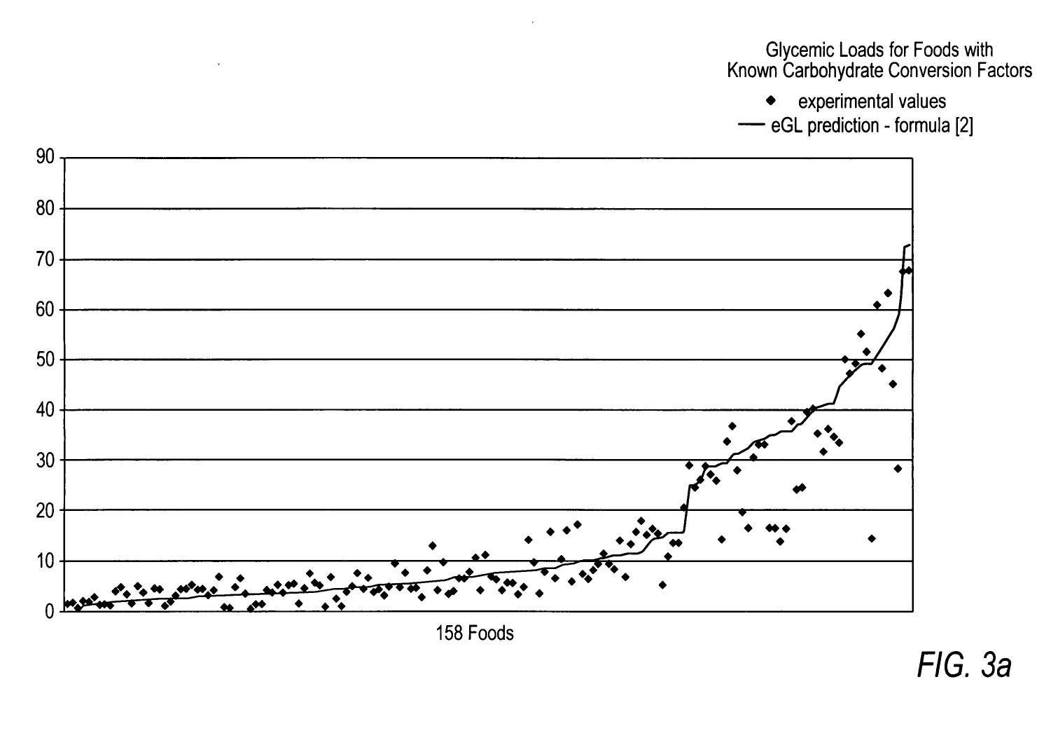

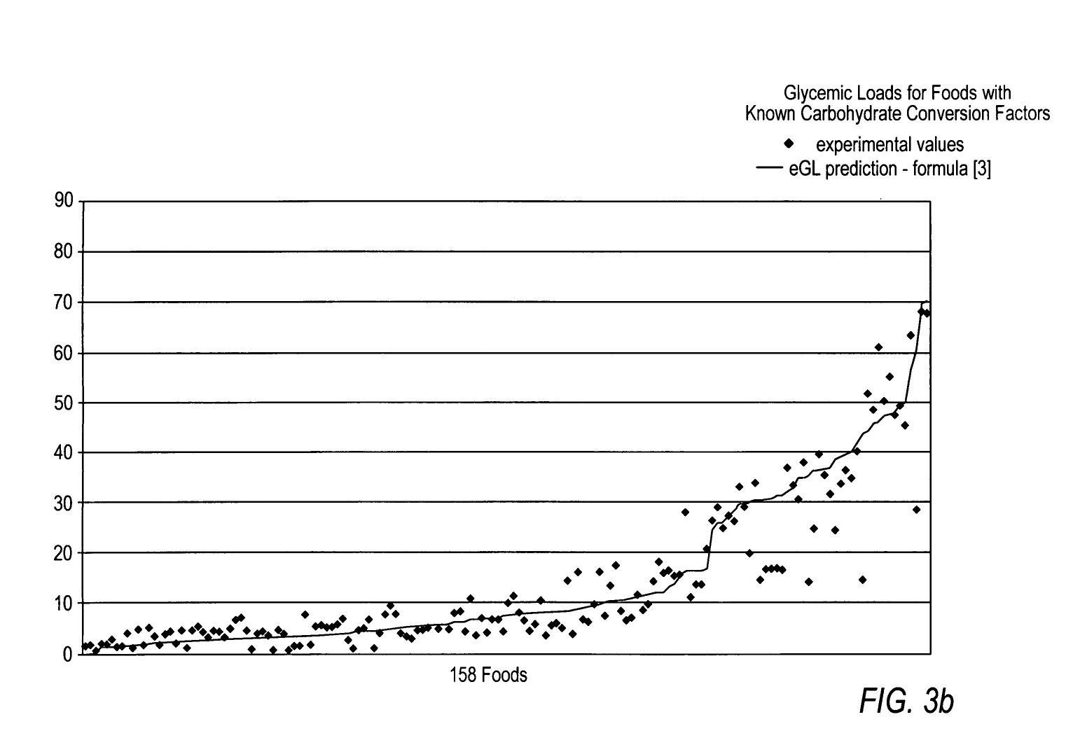

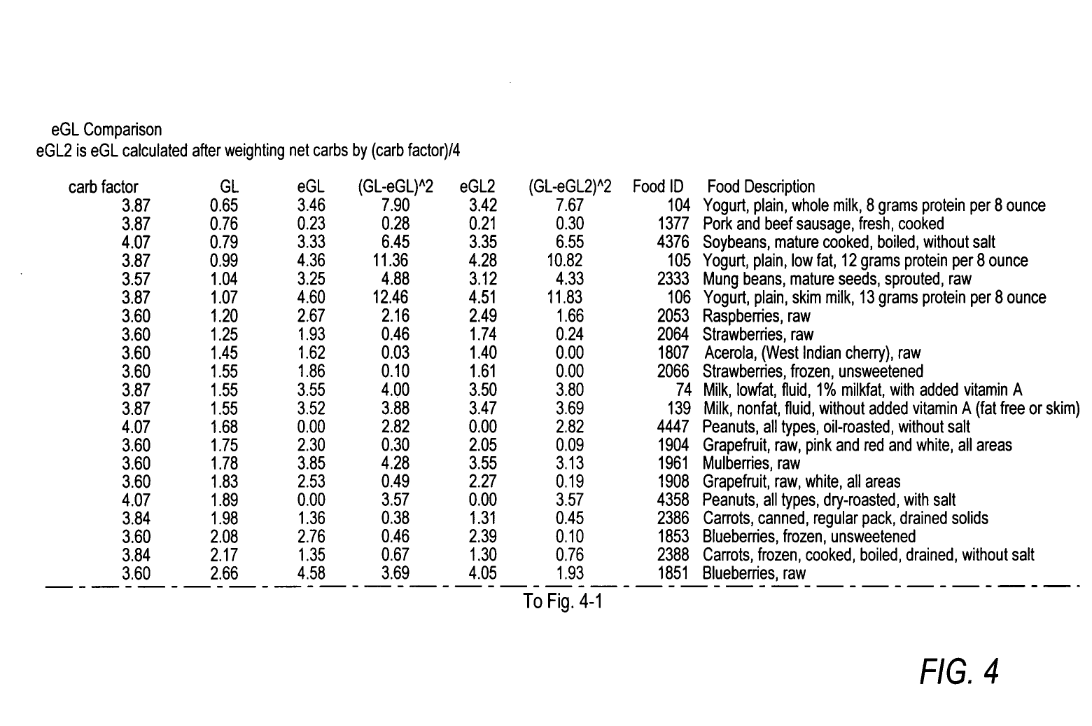

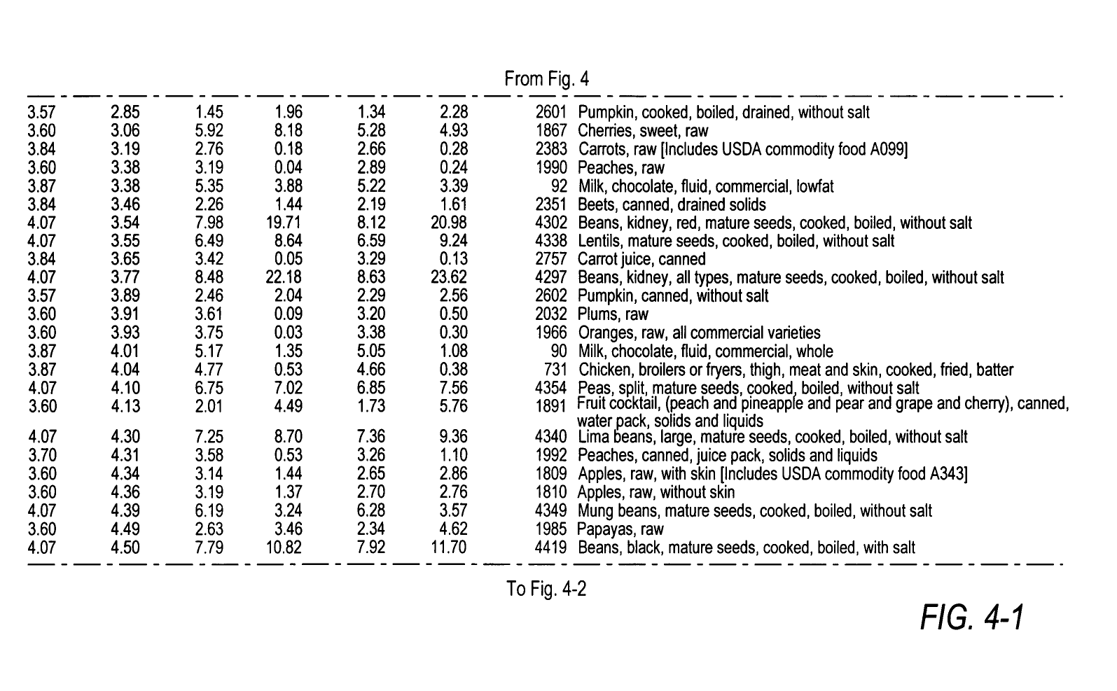

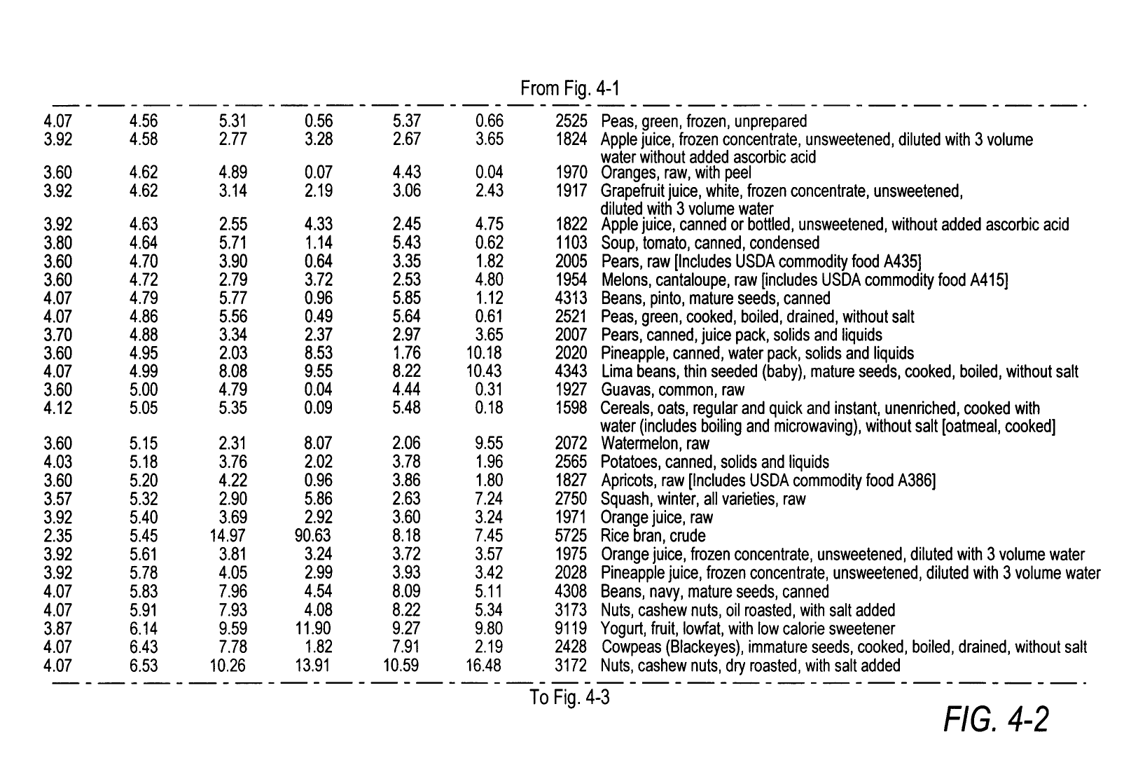

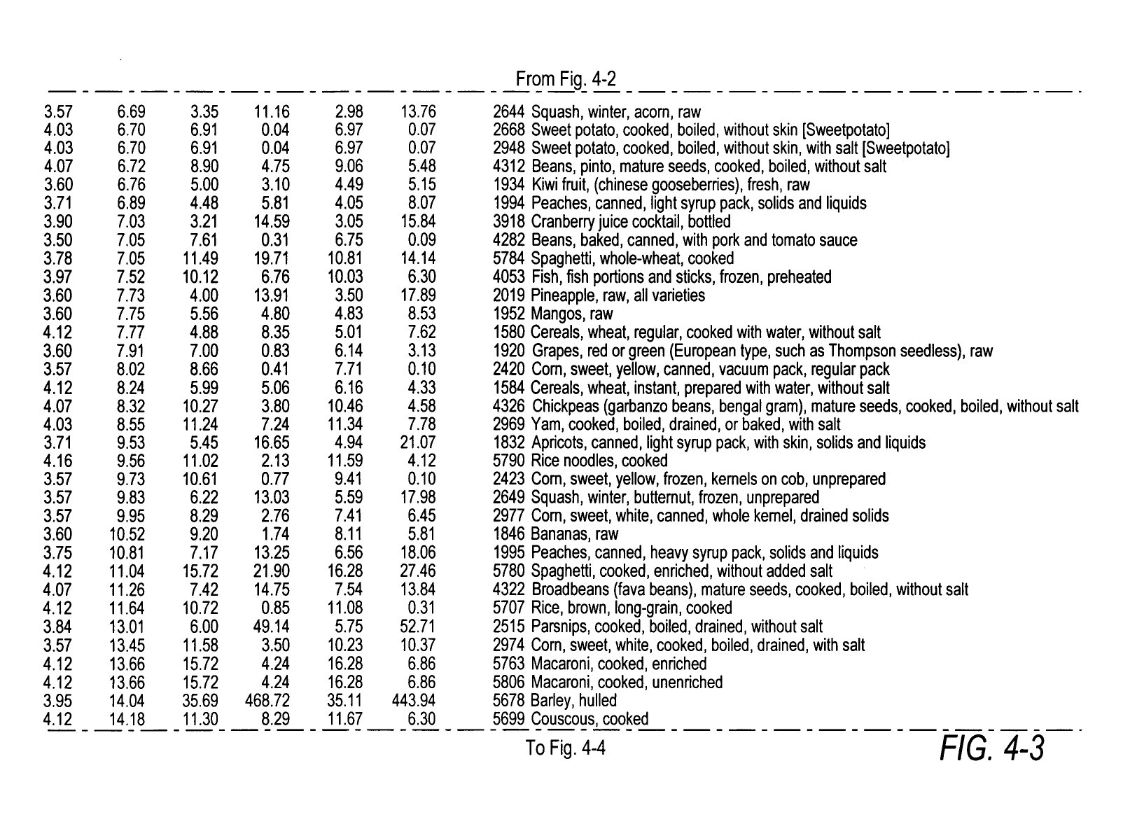

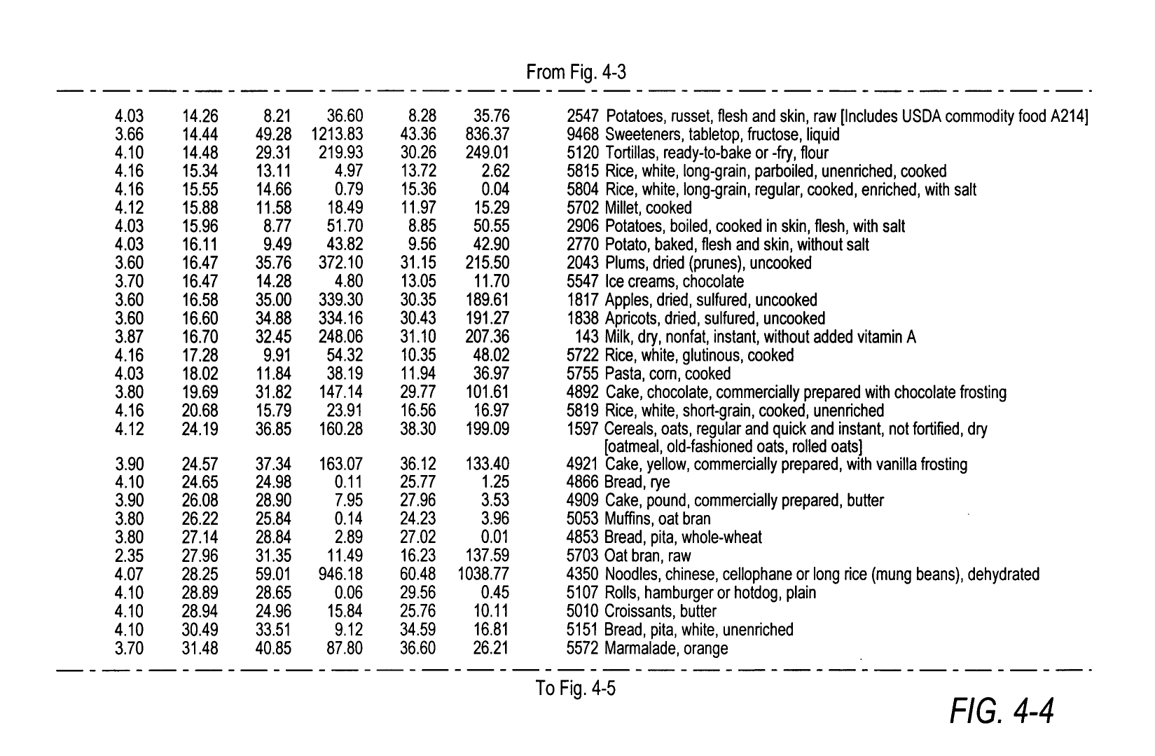

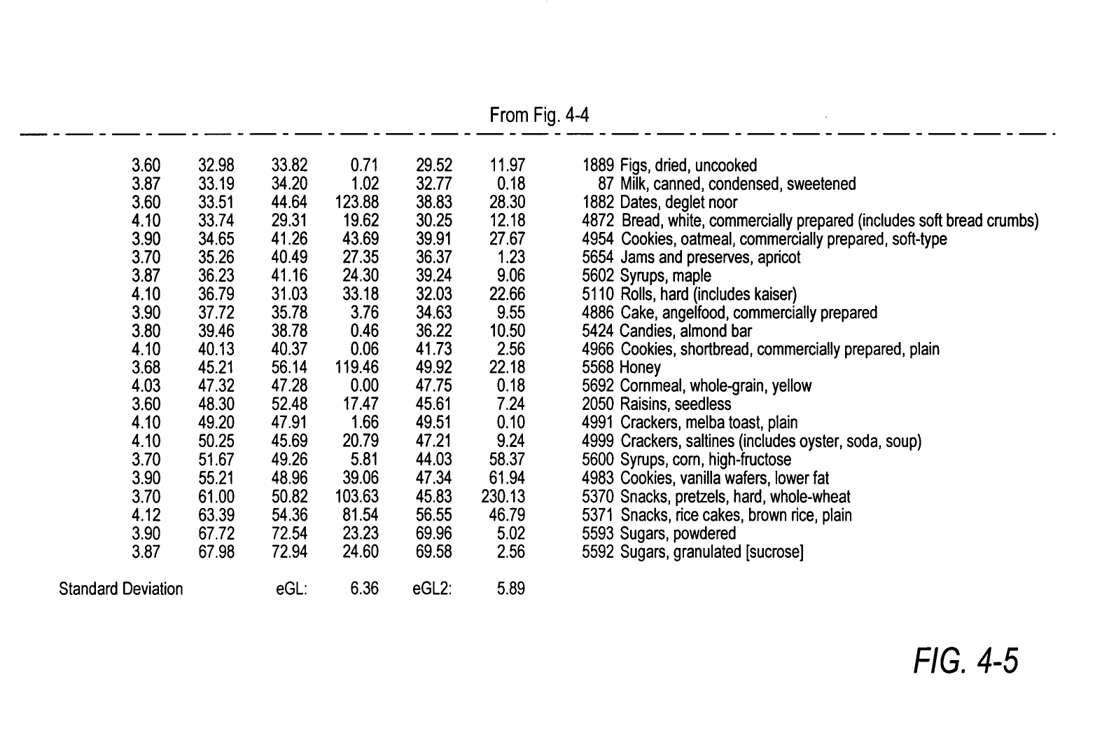

To test the above embodiment [3] relationship, a statistical comparison was performed against embodiment [2] using a sample set of over 150 foods for which both the GL and the CF are known and for which the GL is non-zero. FIGS. 3a and 3b embody this comparison—with FIG. 3a graphically depicting the comparison of actual GLs and estimated GLs using relationship embodiment [2], and FIG. 3b depicting the comparison of actual GLs and GLs estimated using relationship embodiment [3]. The data set underlying the comparative graphical representations of FIGS. 3a and 3b is depicted in FIGS. 4 to 4-5. As indicated in FIGS. 4 to 4-5, relationship [3] provides a better fit for this data, with a standard deviation (from measured GL) of about 7% less than relationship [2].

It should be appreciated that relationship [2] has the advantage of requiring only data that are available on any standard Nutrition Facts label. Relationship embodiment [3] generates equivalent values when the CF is unknown, and provides greater accuracy when it is known.

The USDA provides CF values for many foods. The CF can also be determined by dividing the calories from carbohydrates (if known) by the total grams of non-fiber carbohydrates.

In accordance with the foregoing, the present invention can be used advantageously to select or monitor intake of foods for which the GI is unknown based on anticipated glycemic response for improving health, including for reducing the body's need for insulin and for managing weight loss. Given that the average diet contains many foods for which GI values have yet to be determined, it should be appreciated that, by using the inventive eGL tools to estimate the GLs for these foods, more complete dietary feedback is provided than if the effects of such foods were simply ignored.

In so far as embodiments of the invention described herein are implemented, at least in part, using software controlled programmable processing devices, such as a computer or system of computers, it will be appreciated that one or more computer programs for configuring such devices to implement the foregoing described inventive system and method are to be considered an aspect of the present invention. The computer programs can be embodied as source code and undergo compilation for implementation on processing devices or a system of devices, or can be embodied as object code, for example. Preferably, the computer programs are stored on carrier media in machine or device readable form, for example in solid-state memory or magnetic memory, and processing devices utilize the programs or parts thereof to configure themselves for operation.

It should be appreciated that the aspects, features and advantages made apparent from the foregoing and the accompanying drawings are efficiently attained and, since certain changes may be made in the disclosed constructions and processes without departing from the spirit and scope of the invention, it is intended that all matter contained herein and in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

What is claimed is:

1. A method for estimating the glycemic load of foods, comprising the steps of:
(a) obtaining known glycemic load data for foods of a preselected set of foods;
(b) performing a multivariate statistical analysis on said known glycemic load data;
(c) based on said multivariate statistical analysis, deriving a relationship by which an estimate of glycemic load of at least one food is calculable based on at least one of nutrient levels and serving size;
(d) calculating said estimate of glycemic load for said at least one food; and
(e) providing said estimate of glycemic load to a user for at least one of selecting and monitoring food intake.

2. The method of claim 1, further comprising the steps of obtaining known glycemic index data for said foods of said preselected set of foods, and calculating said known glycemic load data for said foods based at least in part on said known glycemic index data.

3. The method of claim 1, further comprising the step of eliminating from said multivariate statistical analysis ones of said glycemic load data where underlying glycemic index data are equal to zero.

4. The method of claim 1, further comprising the step of eliminating from said multivariate statistical analysis ones of said glycemic load data where underlying glycemic index data are equal to zero and associated calories from carbohydrates are greater than zero.

5. The method of claim 1, further comprising the step of introducing supplemental data into said multivariate statistical analysis.

6. The method of claim 5, wherein said supplemental data include nutrient values for said foods of said preselected set of foods.

7. The method of claim 1, wherein said multivariate statistical analysis is a regression analysis.

8. The method of claim 1, further comprising the step of statistically optimizing results of said multivariate statistical analysis to enable said relationship derived therefrom to best fit said glycemic load data.

9. The method of claim 1, wherein said at least one food is a mix of foods.

10. A method of assessing food, comprising the steps of:
(a) calculating an estimate of glycemic load for at least one food according to the relationship:
eGL=SWT/100*MAX(0,MIN(NC,(X₁+X₂*NĈX₃−X₄*ê(−P)−X₅*F̂X₆)))
where:
eGL=estimated glycemic load,
SWT is the serving weight (in grams),
NC is net carbohydrates (in grams) per 100 g serving,
P is protein (in grams) per 100 g serving,
F is fat (in grams) per 100 g serving,
e is the mathematical constant known as Napier's constant,
MAX(a,b) is a function that returns the maximum of a or b,
MIN(a,b) is a function that returns the minimum of a or b, and
X₁ through X₆ have the approximate following values:
X₁=2.571,
X₂=0.1177,
X₃=1.4,
X₄=3.874,
X₅=0.000059, and
X₆=3.0; and
(b) providing said estimate of glycemic load to a user for at least one of selecting and monitoring food intake.

11. The method of claim 10, wherein said at least one food is a mix of foods.

12. A method of assessing food, comprising the steps of:
(a) calculating an estimate of glycemic load for at least one food according to the relationship:
$$eGL = \frac{SWT}{100} * MAX ( 0 , MIN ( NC , ( \begin{matrix}2.571 + 0.1177 * NC \hat{} 1.4 - \\ 3.874 * e \hat{} ( - P ) - 0.000059 * F \hat{} 3\end{matrix} ) ) )$$
where:
eGL=estimated glycemic load,
SWT is the serving weight (in grams),
NC is net carbohydrates (in grams) per 100 g serving,
P is protein (in grams) per 100 g serving,
F is fat (in grams) per 100 g serving,
e is the mathematical constant known as Napier's constant,
MAX(a,b) is a function that returns the maximum of a or b, and
MIN(a,b) is a function that returns the minimum of a or b; and
(b) providing said estimate of glycemic load to a user for at least one of selecting and monitoring food intake.

13. The method of claim 12, wherein said at least one food is a mix of foods.

14. A method of assessing food, comprising the steps of:
(a) calculating an estimate of glycemic load for at least one food according to the relationship:
$$eGL = \frac{SWT}{100} * MAX ( 0 , MIN ( NC , ( \begin{matrix}{X}_{1} + {X}_{2} * ( NC * CF / 4 ) \hat{} {X}_{3} - \\ {X}_{4} * e \hat{} ( - P ) - {X}_{5} * F \hat{} {X}_{6}\end{matrix} ) ) )$$
where:
eGL=estimated glycemic load,
SWT is the serving weight (in grams),
NC is net carbohydrates (in grams) per 100 g serving,
P is protein (in grams) per 100 g serving,
F is fat (in grams) per 100 g serving,
CF is the carbohydrate conversion factor,
e is the mathematical constant known as Napier's constant,
MAX(a,b) is a function that returns the maximum of a or b,
MIN(a,b) is a function that returns the minimum of a or b, and
X₁ through X₆ have the approximate following values:
X₁=2.571,
X₂=0.1177,
X₃=1.4,
X₄=3.874,
X₅=0.000059, and
X₆=3.0; and
(b) providing said estimate of glycemic load to a user for at least one of selecting and monitoring food intake.

15. The method of claim 14, wherein said at least one food is a mix of foods.

16. A method of assessing food, comprising the steps of:
(a) calculating an estimate of glycemic load for at least one food according to the relationship:
$$eGL = \frac{SWT}{100} * MAX ( 0 , MIN ( NC , ( \begin{matrix}2.571 + 0.1177 * ( NC * CF / 4 ) \hat{} 1.4 - \\ 3.874 * e \hat{} ( - P ) - 0.000059 * F \hat{} 3\end{matrix} ) ) )$$
where:
eGL=estimated glycemic load,
SWT is the serving weight (in grams),
NC is net carbohydrates (in grams) per 100 g serving,
P is protein (in grams) per 100 g serving,
F is fat (in grams) per 100 g serving,
CF is the carbohydrate conversion factor,
e is the mathematical constant known as Napier's constant,
MAX(a,b) is a function that returns the maximum of a or b, and
MIN(a,b) is a function that returns the minimum of a or b; and
(b) providing said estimate of glycemic load to a user for at least one of selecting and monitoring food intake.

17. The method of claim 16, wherein said at least one food is a mix of foods.

18. A food assessment system, comprising:
(a) a general purpose computer programmed to (i) perform a multivariate statistical analysis on known glycemic load data, (ii) based on said multivariate statistical analysis, derive a relationship by which an estimate of glycemic load of at least one food is calculable based on at least one of nutrient levels and serving size, and (iii) calculate said estimate of glycemic load for said at least one food; and
(b) output means for providing said estimate of glycemic load to a user for at least one of selecting and monitoring food intake.

19. A food assessment system, comprising:
(a) a general purpose computer programmed to calculate an estimate of glycemic load for at least one food according to the relationship:
eGL=SWT/100*MAX(0,MIN(NC,(X₁+X₂*NĈX₃−X₄*ê(−P)−X₅*F̂X₆)))
where:
eGL=estimated glycemic load,
SWT is the serving weight (in grams),
NC is net carbohydrates (in grams) per 100 g serving,
P is protein (in grams) per 100 g serving,
F is fat (in grams) per 100 g serving,
e is the mathematical constant known as Napier's constant,
MAX(a,b) is a function that returns the maximum of a or b,
MIN(a,b) is a function that returns the minimum of a or b, and
X₁ through X₆ have the approximate following values:
X₁=2.571,
X₂=0.1177,
X₃=1.4,
X₄=3.874,
X₅=0.000059, and
X₆=3.0; and
(b) output means for providing said estimate of glycemic load to a user for at least one of selecting and monitoring food intake.

20. The system of claim 19, wherein said at least one food is a mix of foods.

21. A food assessment system, comprising:
(a) a general purpose computer programmed to calculate an estimate of glycemic load for at least one food according to the relationship:
$$eGL = \frac{SWT}{100} * MAX ( 0 , MIN ( NC , ( \begin{matrix}2.571 + 0.1177 * NC \hat{} 1.4 - \\ 3.874 * e \hat{} ( - P ) - 0.000059 * F \hat{} 3\end{matrix} ) ) )$$
where:
eGL=estimated glycemic load,
SWT is the serving weight (in grams),
NC is net carbohydrates (in grams) per 100 g serving,
P is protein (in grams) per 100 g serving,
F is fat (in grams) per 100 g serving,
e is the mathematical constant known as Napier's constant,
MAX(a,b) is a function that returns the maximum of a or b, and
MIN(a,b) is a function that returns the minimum of a or b; and
(b) output means for providing said estimate of glycemic load to a user for at least one of selecting and monitoring food intake.

22. The system of claim 21, wherein said at least one food is a mix of foods.

23. A food assessment system, comprising:
(a) a general purpose computer programmed to calculate an estimate of glycemic load for at least one food according to the relationship:
$$eGL = \frac{SWT}{100} * MAX ( 0 , MIN ( NC , ( \begin{matrix}{X}_{1} + {X}_{2} * ( NC * CF / 4 ) \hat{} {X}_{3} - {X}_{4} * \\ e \hat{} ( - P ) - {X}_{5} * F \hat{} {X}_{6}\end{matrix} ) ) )$$
where:
eGL=estimated glycemic load,
SWT is the serving weight (in grams),
NC is net carbohydrates (in grams) per 100 g serving,
P is protein (in grams) per 100 g serving,
F is fat (in grams) per 100 g serving,
CF is the carbohydrate conversion factor,
e is the mathematical constant known as Napier's constant,
MAX(a,b) is a function that returns the maximum of a or b,
MIN(a,b) is a function that returns the minimum of a or b, and
X₁ through X₆ have the approximate following values:
X₁=2.571,
X₂=0.1177,
X₃=1.4,
X₄=3.874,
X₅=0.000059, and
X₆=3.0; and
(b) output means for providing said estimate of glycemic load to a user for at least one of selecting and monitoring food intake.

24. The system of claim 23, wherein said at least one food is a mix of foods.

25. A food assessment system, comprising:
(a) a general purpose computer programmed to calculate an estimate of glycemic load for at least one food according to the relationship:
$$eGL = \frac{SWT}{100} * MAX ( 0 , MIN ( NC , ( \begin{matrix}2.571 + 0.1177 * ( NC * CF / 4 ) \hat{} 1.4 - \\ 3.874 * e \hat{} ( - P ) - 0.000059 * F \hat{} 3\end{matrix} ) ) )$$
where:
eGL=estimated glycemic load,
SWT is the serving weight (in grams),
NC is net carbohydrates (in grams) per 100 g serving,
P is protein (in grams) per 100 g serving,
F is fat (in grams) per 100 g serving,
CF is the carbohydrate conversion factor,
e is the mathematical constant known as Napier's constant,
MAX(a,b) is a function that returns the maximum of a or b,
MIN(a,b) is a function that returns the minimum of a or b; and
(b) output means for providing said estimate of glycemic load to a user for at least one of selecting and monitoring food intake.

26. The system of claim 25, wherein said at least one food is a mix of foods.

27. A computer program product comprising a computer usable physical medium storing a computer executable program to:
(a) compute an estimate of glycemic load for at least one food according to the relationship:
eGL=SWT/100*MAX(0,MIN(NC,(X₁+X₂*NĈX₃−X₄*ê(−P)−X₅*F̂X₆)))
where:
eGL=estimated glycemic load,
SWT is the serving weight (in grams),
NC is net carbohydrates (in grams) per 100 g serving,
P is protein (in grams) per 100 g serving,
F is fat (in grams) per 100 g serving,
e is the mathematical constant known as Napier's constant,
MAX(a,b) is a function that returns the maximum of a or b,
MIN(a,b) is a function that returns the minimum of a or b, and
X₁ through X₆ have the approximate following values:
X₁=2.571,
X₂=0.1177,
X₃=1.4,
X₄=3.874,
X₅=0.000059, and
X₆=3.0; and
(b) provide said estimate of glycemic load to a user for at least one of selecting and monitoring food intake.

28. The computer program product of claim 27, wherein said at least one food is a mix of foods.

29. A computer program product comprising a computer usable physical medium storing a computer executable program to:
(a) compute an estimate of glycemic load for at least one food according to the relationship:
$$eGL = \frac{SWT}{100} * MAX ( 0 , MIN ( NC , ( \begin{matrix}2.571 + .1177 * NC \hat{} 1.4 - 3.874 * \\ e \hat{} ( - P ) - 0.000059 * F \hat{} 3\end{matrix} ) ) )$$
where:
eGL=estimated glycemic load,
SWT is the serving weight (in grams),
NC is net carbohydrates (in grams) per 100 g serving,
P is protein (in grams) per 100 g serving,
F is fat (in grams) per 100 g serving,
e is the mathematical constant known as Napier's constant,
MAX(a,b) is a function that returns the maximum of a or b, and
MIN(a,b) is a function that returns the minimum of a or b; and
(b) provide said estimate of glycemic load to a user for at least one of selecting and monitoring food intake.

30. The computer program product of claim 29, wherein said at least one food is a mix of foods.

31. A computer program product comprising a computer usable physical medium storing a computer executable program to:
(a) compute an estimate of glycemic load for at least one food according to the relationship:
eGL=SWT/100*MAX(0,MIN(NC,(X₁+X₂*(NC*CF/4)̂X₃−X₄*ê(−P)−X₅*F̂X₆)))
where:
eGL=estimated glycemic load,
SWT is the serving weight (in grams),
NC is net carbohydrates (in grams) per 100 g serving,
P is protein (in grams) per 100 g serving,
F is fat (in grams) per 100 g serving,
CF is the carbohydrate conversion factor,
e is the mathematical constant known as Napier's constant,
MAX(a,b) is a function that returns the maximum of a or b,
MIN(a,b) is a function that returns the minimum of a or b, and
X₁ through X₆ have the approximate following values:
X₁=2.571,
X₂=0.1177,
X₃=1.4,
X₄=3.874,
X₅=0.000059, and
X₆=3.0; and
(b) provide said estimate of glycemic load to a user for at least one of selecting and monitoring food intake.

32. The computer program product of claim 31, wherein said at least one food is a mix of foods.

33. A computer program product comprising a computer usable physical medium storing a computer executable program to:
(a) compute an estimate of glycemic load for at least one food according to the relationship:
$$eGL = \frac{SWT}{100} * MAX ( 0 , MIN ( NC , ( \begin{matrix}2.571 + 0.1177 * ( NC * CF / 4 ) \hat{} 1.4 - \\ 3.874 * e \hat{} ( - P ) - 0.000059 * F \hat{} 3\end{matrix} ) ) )$$
where:
eGL=estimated glycemic load,
SWT is the serving weight (in grams),
NC is net carbohydrates (in grams) per 100 g serving,
P is protein (in grams) per 100 g serving,
F is fat (in grams) per 100 g serving,
CF is the carbohydrate conversion factor,
e is the mathematical constant known as Napier's constant,
MAX(a,b) is a function that returns the maximum of a or b, and
MIN(a,b) is a function that returns the minimum of a or b; and
(b) provide said estimate of glycemic load to a user for at least one of selecting and monitoring food intake.

34. The computer program product of claim 33, wherein said at least one food is a mix of foods.
